(19) United States
(12) Patent Application Publication
(10) Pub. No.: US 2005/0041978 A1
(43) Pub. Date: Feb. 24, 2005

(54) Optical signal to noise ratio system

(76) Inventors: Rajeev Roy, Bangalore (IN); Parthasarathi Palai, Bangalore (IN); Krishna Thyagarajan, New Delhi (IN)

Correspondence Address: BURNS DOANE SWECKER & MATHIS L L P, POST OFFICE BOX 1404, ALEXANDRIA, VA, 22313-1404, US

(21) Appl. No.: 10/491,662

(22) PCT Filed: Oct. 3, 2001
(86) PCT No.: PCT/IN01/00166

(51) Int. Cl. H04J 14/02

(52) U.S. Cl. 398/97

(57) ABSTRACT

The present invention provides a system for improving Optical Signal to Noise Ratio “OSNR” (208) of a transmission system using non gain-flattened optical amplifiers (101) and also provide an optically amplified Dense Wavelength Division Multiplexed “DWDM” transmission system that incorporates aforesaid system and has improved channel OSNR (208).

### TECHNICAL FIELD

The present invention relates to a system for improving Optical Signal to Noise Ratio (OSNR) of a transmission system using non gain-flattened optical amplifiers. The present invention also relates to an optically amplified Dense Wavelength Division Multiplexed (DWDM) transmission system that incorporates aforesaid system and has improved channel OSNR.

### BACKGROUND ART

In DWDM transmission systems, optical amplifiers are an integral part. In general, erbium doped fiber amplifiers (EDFA) are used to amplify multiple channels. The use of optical amplifiers results in the generation of noise. This generation is intrinsic to the amplification process. The ratio of the optical signal power to the optical noise power is called the Optical Signal to Noise Ratio (OSNR) and is a measure of the quality of the signal transmission. The intrinsic gain spectrum of an EDFA consists of several peaks and valleys. In a chain of cascaded amplifiers the signal near the peak of the gain will grow at the expense of other signals. Hence the optical signal to noise ratio (OSNR) for different channels will be different even if at the input to the link, they were same.

Quite a few ways have been demonstrated over the years to flatten the spectral gain characteristics and hence, to effectively improve the relative OSNR variation between the channels. These methods can be categorized under three categories a) Glass composition method, b) Spectral equalizer method and c) Hybrid amplifier method. In all these methods one has to use either special materials for the optical fiber instead of silica or optical filters with special spectral characteristics, which are not very cost effective for multi span DWDM transmission system with multiple amplifiers. It has also been shown that OSNR can be improved by signal pre-emphasis at the beginning of the link. In practice it might not be always possible to control the transmitter power in order to implement this scheme. A good description of the above-mentioned schemes can be found in “Erbium-Doped Amplifiers: Fundamentals and Technology” by P. C Becker et al, Academic Press, 1999.

In one of the interesting schemes, it has been shown that OSNR of the system can be improved by demultiplexing the signal channels in the middle of the link and carrying out the spectral equalization by using separate amplifier for each channel and multiplexing them by an optical multiplexer for onward transmission. A publication by L. Eskildsen et al., IEEE Photon. Tech. Lett 6,1321 (1994) gives a description of a similar scheme. The drawback of such a scheme is that as the channel count increases the system will become expensive due to the use of separate optical amplifiers for each channel.

### OBJECTS OF THE INVENTION

The main object of the present invention is to provide a system to improve the Optical Signal to Noise Ratio (OSNR) of channels of a transmission system.

Another object of the present invention is to provide a system which uses non gain-flattened optical amplifiers in a multichannel transmission system for reducing the relative variation in the OSNR across the channels.

Yet another object of the present invention is to provide a system for increasing the number of spans of a multichannel transmission system using non gain-flattened EDFAs.

Still another object of the present invention is to provide a system for alleviating the OSNR limitation on the link length of a multichannel transmission system using non gain-flattened EDFAs.

One more object of the present invention is to provide an optically amplified Dense Wavelength Division Multiplexed (DWDM) transmission system that incorporates aforesaid system and has improved channel OSNR.

### SUMMARY OF THE INVENTION

Accordingly, the present invention provides a system for improving Optical Signal to Noise Ratio (OSNR) of a transmission system using non gain-flattened optical amplifiers. The present invention also provides an optically amplified Dense Wavelength Division Multiplexed (DWDM) transmission system that incorporates aforesaid system and has improved channel OSNR.

### DETAILED DESCRIPTION OF THE PRESENT INVENTION

Accordingly, the present invention provides a system for improving Optical Signal to Noise Ratio (OSNR) of a transmission system using non gain-flattened optical amplifiers, said system comprising a non gain-flattened optical amplifier (101) connected to a

Demultiplexer (102) which splits the multichannel optical signal into its individual channels, a part of which is passed through a Coupling mechanism (103) and a Detector (104), and the other part is directly fed to a Variable Optical Attenuator (VOA) (106), signals from all detectors are fed to a Signal Processing Unit (105) whose output controls the setting of all the VOAs and outputs from all VOAs being connected to a Multiplexer (107).

In an embodiment of the present invention, the non gain-flattened optical amplifier is an Erbium Doped Fiber Amplifier (EDFA).

In another embodiment of the present invention, the EDFA incorporates an amplified spontaneous emission (ASE) rejection filter.

In still another embodiment of the present invention, the EDFA amplifies the incoming optical signal.

In yet another embodiment of the present invention, the gain of EDFA is set to overcome insertion losses due to the Demultiplexer, Coupling mechanism, Variable Optical Attenuators and Multiplexer and also to amplify the signal.

In one more embodiment of the present invention, the EDFA is set for constant gain operation.

In one another embodiment of the present invention, the Coupling mechanism is a Tap Coupler.

In one further embodiment of the present invention, the Tap Coupler has a coupling ratio of 99:1.

In an embodiment of the present invention, the tapped signals are detected using individual detectors.

In another embodiment of the present invention, the detected signals are fed to the Signal Processing Unit.

In still another embodiment of the present invention, the Signal Processing Unit produces electric signals.

In yet another embodiment of the present invention, the electric signals control the settings of corresponding Variable Optical Attenuators.

In one more embodiment of the present invention, the VOA setting is controlled to obtain pre-emphasis in the channels.

In one another embodiment of the present invention, the pre-emphasis of channels is achieved by setting the attenuation values of the channels that undergo lower gain to a relatively lower value than for the channels undergoing a relatively higher gain in the non gain-flattened amplifiers.

In an embodiment of the present invention, the pre-emphasis given to the channels is in accordance with the gain profile of the EDFAs.

The present invention also provides an optically amplified Dense Wavelength Division Multiplexed (DWDM) transmission system having improved channel OSNR, said transmission system comprising an Array of Transmitters (201) whose output is multiplexed using a Multiplexer (202), the multiplexed signal is amplified using a Booster Amplifier (203) and launched into a number of spans, one or more systems to improve the OSNR as herein described before (208) connected in between the spans, the signal from the last span is given to a Demultiplexer (209) and the demultiplexed signal is detected using an array of receivers (210).

In an embodiment of the present invention, the transmitter array consists of 10 Gbps externally modulated lasers (EML).

In another embodiment of the present invention, the transmitter array includes 16 channels from ITU-T grid no. 22 to 37.

In still another embodiment of the present invention, the Booster Amplifier is a non gain-flattened EDFA operating under constant power configuration.

In yet another embodiment of the present invention, the transmission system comprises of twelve spans.

In one more embodiment of the present invention, each span consists of 80 Km of ITU-T G. 652 compliant Single Mode Fibers (SMF) (206), a Dispersion Compensation Fiber (DCF) (204), two Inline Amplifiers ILA1 (207) and ILA2 (205).

In one another embodiment of the present invention, the DCF (204) compensates the accumulated dispersion of each span.

In an embodiment of the present invention, the Inline Amplifier (ILA2) (205) makes up the nominal loss in the DCF.

In another of the present invention, the Inline Amplifier (ILA1) (207) makes up for the nominal loss in the SMF.

In still another embodiment of the present invention, the Inline Amplifiers (ILA1 and ILA2) are non gain-flattened EDFAs.

In yet another embodiment of the present invention, ILA1 and ILA2 are operated under constant gain conditions.

In on more embodiment of the present invention, the system to improve the OSNR (208) is implemented after the fourth span.

### BRIEF DESCRIPTION OF THE ACCOMPANYING DRAWINGS

In the drawings accompanying the specification,

FIG. 1 is a schematic configuration of the technique used to improve the OSNR

FIG. 2 is a schematic diagram of the DWDM transmission system

FIG. 3 is the illustration of the spectrum of the signal after the Booster Amplifier

FIG. 4 is the illustration of the spectrum of the signal at the end of the 5^{th} span, without any spectral reshaping.

FIG. 5 is the illustration of the spectrum just after the implementation of the scheme to improve OSNR at the end of the 4^{th} Span.

FIG. 6 is the illustration of the spectrum of the signals after the 5^{th} span where the implementation of the scheme to improve the OSNR is carried out in a DWDM multi-span link after the 4^{th} span.

FIG. 7 is the illustration of the spectrum of the signals after the 9^{th} span where the implementation of the scheme to improve the OSNR is carried out in a DWDM multi-span link after the 4^{th} span.

FIG. 8 is the illustration of the OSNR map when the scheme to improve the OSNR is not implemented

FIG. 9 is the illustration of the OSNR map when the scheme to improve the OSNR is implemented.

### BRIEF DESCRIPTION OF THE ACCOMPANYING TABLES

In the tables accompanying the specification,

Table 1 provides a list of parameters used to simulate the DWDM link performance using VPItransmissionmaker™ WDM software

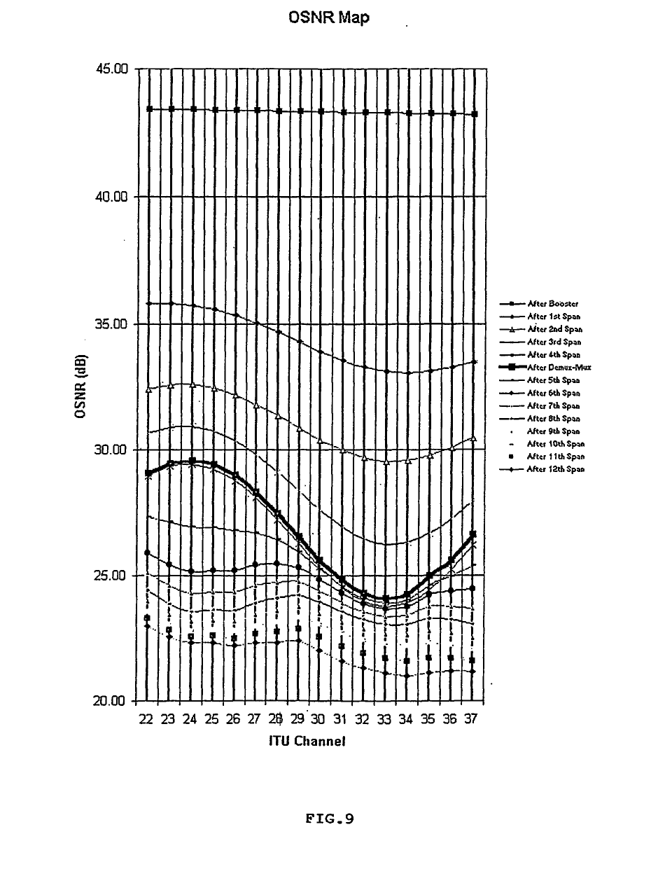

Table 2 provides the numbers corresponding to the graphical representation of the OSNR of all channels from spans 1 through 12 and at the output of the system 208 as illustrated by FIG. 9.

Table 3 provides the data showing the improvement in the OSNR in each of the individual channels over the entire span, once the system 208 is implemented after the fourth span.

The foregoing and other aspects and advantages will be better understood from the following detailed description of preferred embodiments of the invention which are given by way of illustration and therefore should not be construed to limit the scope of the present invention in any manner. The preferred embodiments are described in detail with reference to the drawings for a multiple span DWDM link consisting of 16 channels and several spans.

### DETAILED DESCRIPTION OF PREFERRED EMBODIMENTS

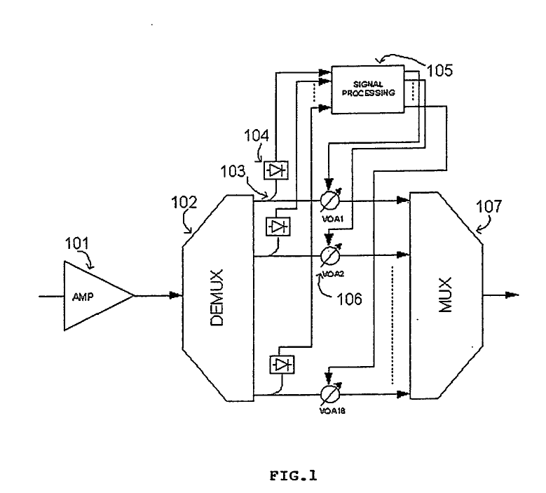

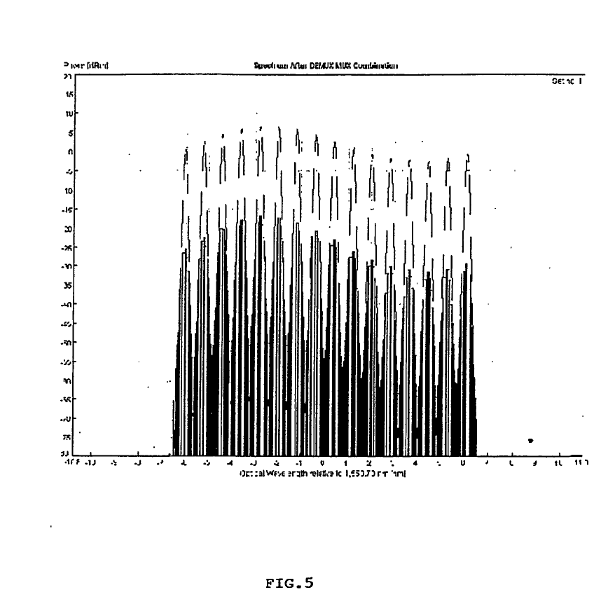

Referring now to the drawings, and more particularly to FIG. 1, a procedure is shown, through which the OSNR improvement is achieved. A non gain-flattened optical amplifier 101, which incorporates an amplified spontaneous emission (ASE) rejection filter, is used to amplify the incoming signal. The amplifier gain setting is done such that the insertion losses due to the demultiplexer, tap couplers, Variable Optical Attenuators (VOAs) and multiplexer are overcome and further amplification of the signal is achieved. The amplified signal is passed through a demultiplexer 102. Tap Couplers (99:1) 103 (not all 16 are illustrated) are used to tap the signals from the demultiplexed signals. The tapped signals are detected by individual detectors 104 (not all 16 are illustrated) and fed to the Signal Processing Unit 105. The Signal Processing Unit 105 controls the settings of the VOAs 106 (not all 16 illustrated) through electrical signals. The demultiplexed signals are passed through the VOAs. The VOA settings, which are controlled by the Signal Processing Unit, are done such that a pre-emphasis is achieved in the channels. The pre-emphasis of channels is achieved by setting the attenuation values of channels that undergo lesser gain in the non-gain flattened amplifiers to follow if the scheme is implemented in a link, to a relatively lower value than for channels undergoing a relatively higher gain. FIG. 5 illustrates the pre-emphasis given to certain channels in a simulation of a link, the details of which are mentioned later in the document with specific reference to Table 1. It should be noted that the pre-emphasis given to channels must be in accordance with the gain profile of the non gain-flattened amplifiers in the spans following the one in which the scheme is being implemented. The channels, which undergo lesser amplification, are given a correspondingly higher power so that they have the same power levels, as those of the channels undergoing higher amplification in the subsequent spans. The individual signals are multiplexed by the multiplexer 107 for onward transmission.

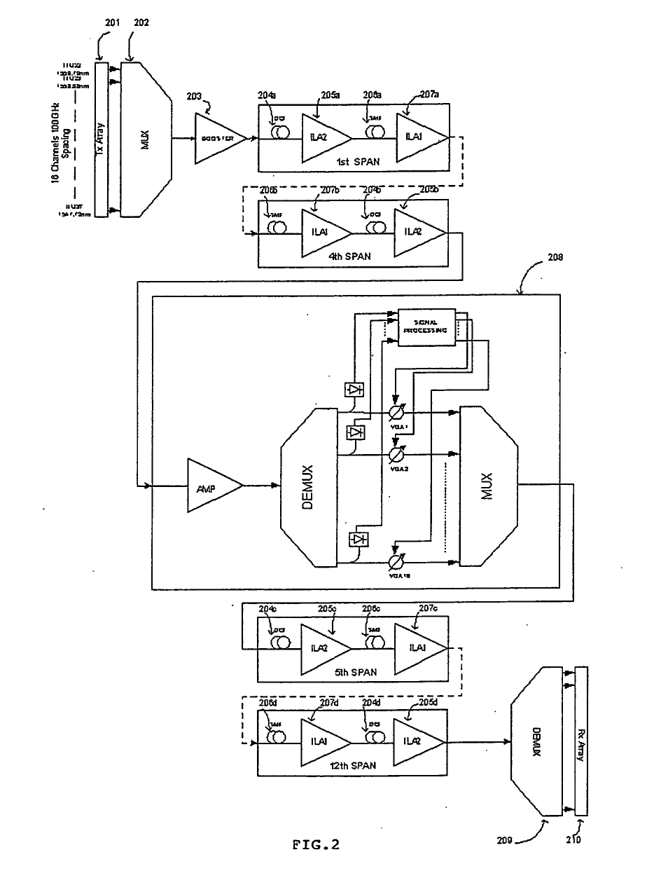

FIG. 2 is illustrating the use of the scheme to improve the OSNR in a multi-span optically amplified DWDM transmission system. The output of a Transmitter Array 201 is multiplexed using a Multiplexer 202. The signal is then boosted by a non gain-flattened Booster Amplifier 203 and launched into the first span. For the sake of clarity only span number one, four, five and twelve are illustrated. The Dispersion Compensating Fibers (DCF) in span numbers one, four, five and twelve are denoted by 204a, 204b, 204c, and 204d, respectively. The ITU-T G.652 compliant Single Mode Fiber (SMF) in span numbers one, four, five and twelve are denoted by 206a, 206b, 206c, and 206d respectively. In each span the accumulated dispersion is more or less compensated by the DCF over the signal band (see Table 1). The non gain-flattened Inline Amplifiers used to make up for the nominal loss in the SMF is denoted by ILA1 and are represented in the figure in span number one, four, five and twelve by 207a, 207b, 207c and 207d, respectively. The non gain-flattened Inline Amplifiers used to make up for the nominal loss in the DCF is denoted by ILA2 and are represented in the figure in span number one, four, five and twelve by 205a, 205b, 205c and 205d, respectively. The scheme to improve the OSNR 208 is implemented after the fourth span. The detailed working of the same has been explained earlier with reference to FIG. 1. The signal coming out of the multiplexer is introduced to the next span, namely the fifth span and it gets transmitted to the subsequent spans. The signal is demultiplexed using the Demultiplexer 209. The demultiplexed signals are detected by an array of receivers 210.

The simulation parameters used to simulate the link using VPItransmissionmaker™ WDM are illustrated in Table 1. The transmitter array includes 16 Channels from ITU-T grid no. 22 to 37 consisting of 10 Gbps externally modulated laser (EML). The signals are multiplexed using a multiplexer and thereafter boosted by a non gain-flattened booster EDFA operated under a constant power configuration. Each span consists of 80 km of ITU-T G.652 compliant fibers. Link loss is compensated by a non-gain flattened EDFA operating under constant gain condition. The accumulated dispersion of each span is compensated by a Dispersion Compensating Fiber (DCF) and the loss incurred in the DCF length is compensated by another non-gain flattened EDFA operating under constant gain condition. The scheme to improve the OSNR as has been detailed in FIG. 1 has been implemented after the fourth span.

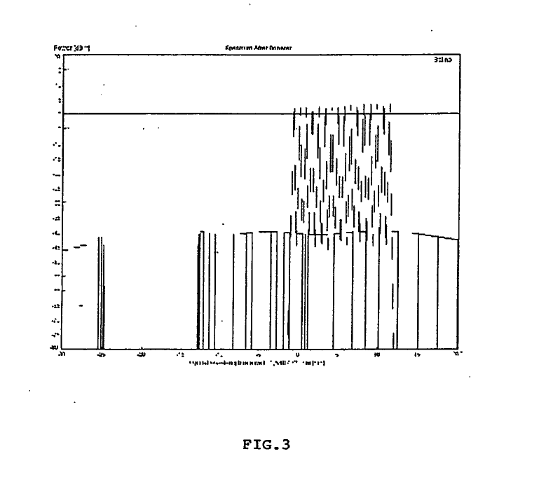

FIG. 3 illustrates the spectrum after the Booster Amplifier. In the 1530 nm region, the gap in the spectrum is attributed to the amplified spontaneous emission (ASE) rejection filter used with each amplifier in order to prevent the saturation of the subsequent amplifiers in the link by ASE noise. It can be observed from the figure that the spectrum of the transmitters is more or less flat after the booster amplifier.

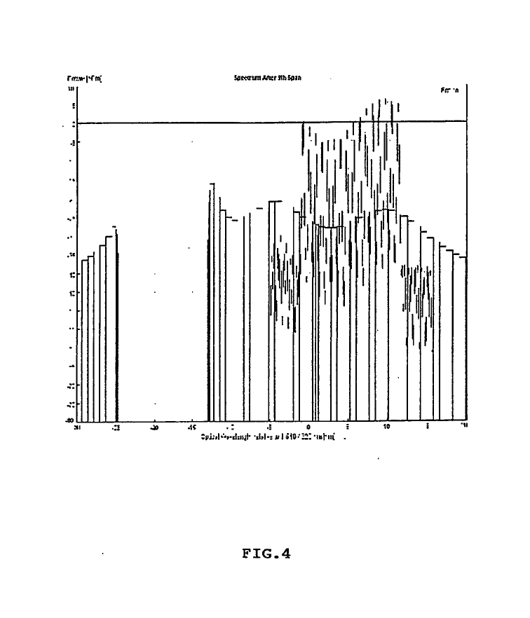

For comparison, FIG. 4 illustrates the spectrum after the fifth span wherein the scheme to improve the OSNR is not implemented. It can be observed that there are peaks and valleys of the amplifier in the signal band. The valleys degrade the OSNR considerably.

FIG. 5 illustrates the spectrum after the implementation of the scheme to improve the OSNR. The spectrum is noted at the point where the signal is launched into the fifth span. In this figure it should be noted that the channels are pre-emphasized in accordance with the output spectral gain characteristics of the non-gain flattened EDFAs to be traversed from the fifth span onwards.

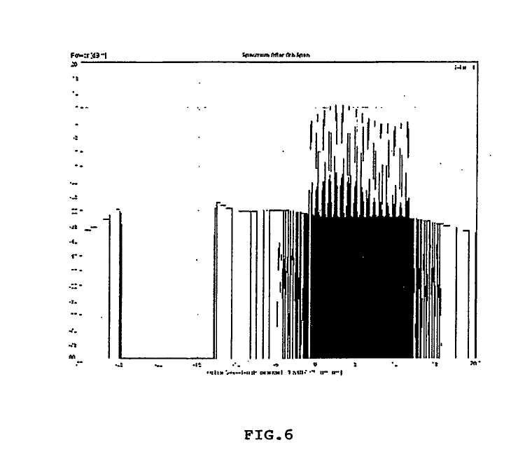

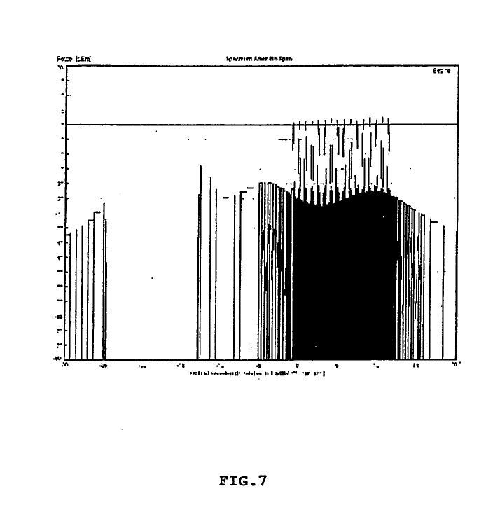

FIG. 6 illustrates the spectrum at the end of the fifth span where the scheme to improve the OSNR is carried out at the end of the fourth span. As had been mentioned earlier with reference to FIG. 5 that pre-emphasis given to channels and can be seen in this figure also. The pre-emphasis is such that at the end of the 9^{th} span, all channels have almost the same power. This is illustrated in FIG. 7.

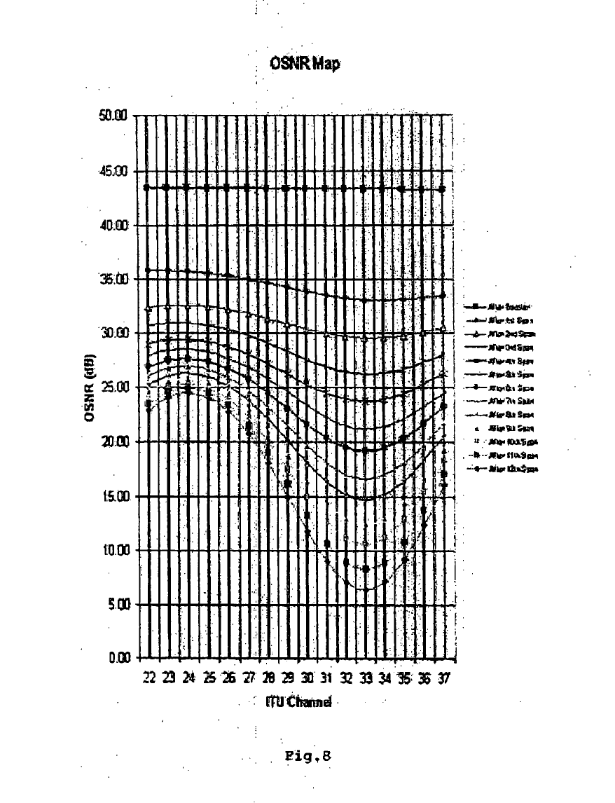

The OSNR map, when channels are transmitted across all twelve spans without the implementation of the scheme to improve the OSNR, is illustrated in FIG. 8. The improvement in the OSNR after the implementation of the scheme can be seen in FIG. 9. The corresponding data is tabulated in Table 2. The data showing the improvement in the OSNR in each of the individual channels over the entire span, once the system 208 is implemented after the fourth span is tabulated in Table 3. There is a substantial improvement in the OSNR of the transmitted channels up to 12 spans. The implementation of the scheme to improve the OSNR results in all channels having a Bit Error Rate (BER) of less than 1 in 10¹⁵ even at the end of the twelfth span.

TABLE 1
List of parameters used to simulate the DWDM link, as detailed in
FIG. 2, using VPItransmissionmaker ™ WDM software.

| PARAMETER | VALUE |
|---|---|
| Data Rate | 10 Gbit/s (STM 64) |
| Length of SMF | 80 km |
| Attenuation SMF | 0.25 dB/km @ 193.40 THz |
| Dispersion Coefficient | 17 ps/km/nm @ 193.40 THz |
| SMF | |
| Dispersion Slope SMF | 0.057 ps/km-nm² @ 193.40 THz |
| Non Linear Index SMF | 2.6 × 10⁻²⁰ m²/W @ 193.40 THz |
| Length DCF | 14.66 km |
| Attenuation DCF | 0.60 dB/km @ 194.17 THz |
| Dispersion Coefficient | −90 ps/km/nm @ 194.17 THz |
| DCF | |
| Dispersion Slope DCF | −0.18 ps/km-nm² @ 194.17 THz |
| Non Linear Index DCF | 4 × 10⁻²⁰ m²/W @ 194.17 THz |
| Booster Amplifier | 15 dBm Constant Power Mode |
| Inline Amplifier | ILA 1:20 dB Constant Gain Mode; |
| | ILA 2: 9 cAB Constant Gain Mode |
| Source Power | 0 dBm/Charmel |
| MUX Loss | 6 dB |
| DEMUX Loss | 6 dB |
| Amplifier “AMP” | 24 dB Constant Gain Mode |

TABLE 2
The numbers corresponding to the graphical representation of the OSNR of all channels from spans 1 through 12
and at the output of the system 208 as illustrated by FIG. 9 are given in the table below.

| | OSNR (dB) | | | | | | | | | | | | | |
|---|---|---|---|---|---|---|---|---|---|---|---|---|---|---|
| | | After | After | After | After | After | After | After | After | After | After | After | After | After |
| ITU | After | 1^{st} | 2^{nd} | 3^{rd} | 4^{th} | system | 5^{th} | 6^{th} | 7^{th} | 8^{th} | 9^{th} | 10^{th} | 11^{th} | 12^{th} |
| Channel | Booster | Span | Span | Span | Span | 208 | Span | Span | Span | Span | Span | Span | Span | Span |
| 22 | 43.41 | 35.79 | 32.44 | 30.67 | 28.97 | 29.08 | 27.35 | 25.89 | 25.13 | 24.41 | 24.00 | 23.58 | 23.30 | 23.00 |
| 23 | 43.40 | 35.81 | 32.59 | 30.92 | 29.35 | 29.49 | 27.14 | 25.43 | 24.60 | 23.87 | 23.47 | 23.08 | 22.83 | 22.57 |
| 24 | 43.39 | 35.74 | 32.60 | 30.95 | 29.43 | 29.60 | 26.95 | 25.16 | 24.31 | 23.58 | 23.18 | 22.81 | 22.57 | 22.32 |
| 25 | 43.38 | 35.58 | 32.46 | 30.76 | 29.24 | 29.43 | 26.92 | 25.20 | 24.35 | 23.63 | 23.22 | 22.84 | 22.59 | 22.34 |
| 26 | 43.37 | 35.34 | 32.19 | 30.37 | 28.77 | 28.99 | 26.79 | 25.20 | 24.35 | 23.63 | 23.19 | 22.78 | 22.49 | 22.20 |
| 27 | 43.36 | 35.03 | 31.82 | 29.82 | 28.09 | 28.33 | 26.72 | 25.42 | 24.61 | 23.92 | 23.45 | 23.01 | 22.66 | 22.32 |
| 28 | 43.35 | 34.66 | 31.36 | 29.13 | 27.24 | 27.50 | 26.43 | 25.46 | 24.75 | 24.11 | 23.62 | 23.15 | 22.74 | 22.33 |
| 29 | 43.33 | 34.27 | 30.88 | 28.37 | 26.29 | 26.57 | 25.96 | 25.33 | 24.78 | 24.25 | 23.78 | 23.32 | 22.87 | 22.40 |
| 30 | 43.32 | 33.89 | 30.40 | 27.61 | 25.35 | 25.65 | 25.26 | 24.84 | 24.40 | 23.96 | 23.51 | 23.06 | 22.55 | 22.03 |
| 31 | 43.31 | 33.55 | 30.00 | 26.95 | 24.55 | 24.86 | 24.60 | 24.29 | 23.94 | 23.57 | 23.15 | 22.71 | 22.17 | 21.61 |
| 32 | 43.30 | 33.28 | 29.70 | 26.47 | 23.99 | 24.31 | 24.11 | 23.88 | 23.58 | 23.26 | 22.87 | 22.45 | 21.90 | 21.33 |
| 33 | 43.28 | 33.11 | 29.55 | 26.24 | 23.76 | 24.10 | 23.91 | 23.68 | 23.39 | 23.08 | 22.69 | 22.27 | 21.71 | 21.13 |
| 34 | 43.27 | 33.06 | 29.58 | 26.32 | 23.92 | 24.28 | 24.04 | 23.77 | 23.42 | 23.07 | 22.64 | 22.20 | 21.61 | 21.02 |
| 35 | 43.25 | 33.11 | 29.77 | 26.68 | 24.44 | 25.01 | 24.62 | 24.22 | 23.75 | 23.31 | 22.80 | 22.32 | 21.71 | 21.14 |
| 36 | 43.24 | 33.26 | 30.09 | 27.26 | 25.25 | 25.64 | 24.98 | 24.39 | 23.78 | 23.26 | 22.72 | 22.25 | 21.69 | 21.20 |
| 37 | 43.22 | 33.48 | 30.50 | 27.99 | 26.22 | 26.63 | 25.40 | 24.48 | 23.67 | 23.07 | 22.51 | 22.06 | 21.58 | 21.18 |

TABLE 3
The improvement in the OSNR in the various spans, once the system 208 is implemented after the fourth
span, over a link where system 208 is not implemented, is given in the table below.

| | OSNR IMROVEMENT (dB) | | | | | | | | | | | | |
|---|---|---|---|---|---|---|---|---|---|---|---|---|---|
| | | After | After | After | After | After | After | After | After | After | After | After | After |
| ITU | After | 1st | 2nd | 3rd | 4th | 5th | 6th | 7th | 8th | 9th | 10th | 11th | 12th |
| Channel | Booster | Span | Span | Span | Span | Span | Span | Span | Span | Span | Span | Span | Span |
| 22 | 0.00 | 0.00 | 0.00 | 0.00 | 0.00 | −0.60 | −1.01 | −0.95 | −0.85 | −0.64 | −0.40 | −0.16 | 0.11 |
| 23 | 0.00 | 0.00 | 0.00 | 0.00 | 0.00 | −1.28 | −2.06 | −2.17 | −2.20 | −2.08 | −1.93 | −1.76 | −1.56 |
| 24 | 0.00 | 0.00 | 0.00 | 0.00 | 0.00 | −1.58 | −2.49 | −2.65 | −2.72 | −2.62 | −2.50 | −2.35 | −2.17 |
| 25 | 0.00 | 0.00 | 0.00 | 0.00 | 0.00 | −1.38 | −2.19 | −2.32 | −2.36 | −2.23 | −2.09 | −1.91 | −1.71 |
| 26 | 0.00 | 0.00 | 0.00 | 0.00 | 0.00 | −0.94 | −1.55 | −1.56 | −1.52 | −1.32 | −1.12 | −0.87 | −0.61 |
| 27 | 0.00 | 0.00 | 0.00 | 0.00 | 0.00 | −0.17 | −0.35 | −0.13 | 0.09 | 0.44 | 0.77 | 1.15 | 1.52 |
| 28 | 0.00 | 0.00 | 0.00 | 0.00 | 0.00 | 0.63 | 0.96 | 1.54 | 2.01 | 2.60 | 3.11 | 3.70 | 4.23 |
| 29 | 0.00 | 0.00 | 0.00 | 0.00 | 0.00 | 1.38 | 2.26 | 3.31 | 4.13 | 5.06 | 5.83 | 6.71 | 7.45 |
| 30 | 0.00 | 0.00 | 0.00 | 0.00 | 0.00 | 1.91 | 3.20 | 4.71 | 5.84 | 7.13 | 8.14 | 9.33 | 10.28 |
| 31 | 0.00 | 0.00 | 0.00 | 0.00 | 0.00 | 2.31 | 3.89 | 5.79 | 7.17 | 8.80 | 10.03 | 11.51 | 12.63 |
| 32 | 0.00 | 0.00 | 0.00 | 0.00 | 0.00 | 2.58 | 4.33 | 6.50 | 8.05 | 9.92 | 11.30 | 12.99 | 14.23 |
| 33 | 0.00 | 0.00 | 0.00 | 0.00 | 0.00 | 2.68 | 4.45 | 6.72 | 8.30 | 10.25 | 11.66 | 13.43 | 14.69 |
| 34 | 0.00 | 0.00 | 0.00 | 0.00 | 0.00 | 2.59 | 4.24 | 6.38 | 7.84 | 9.68 | 10.98 | 12.66 | 13.83 |
| 35 | 0.00 | 0.00 | 0.00 | 0.00 | 0.00 | 2.47 | 3.83 | 5.62 | 6.82 | 8.37 | 9.45 | 10.88 | 11.88 |
| 36 | 0.00 | 0.00 | 0.00 | 0.00 | 0.00 | 1.74 | 2.67 | 3.99 | 4.86 | 6.04 | 6.87 | 7.99 | 8.80 |
| 37 | 0.00 | 0.00 | 0.00 | 0.00 | 0.00 | 0.86 | 1.19 | 1.92 | 2.42 | 3.19 | 3.75 | 4.54 | 5.12 |

1. A system for improving Optical Signal to Noise Ratio (OSNR) of a transmission system using non gain-flattened optical amplifiers, said system comprising a non gain-flattened optical amplifier (101) connected to a Demultiplexer (102) which splits the multichannel optical signal into its individual channels, a part of which is passed through a Coupling mechanism (103) and a Detector (104), and the other part is directly fed to a Variable Optical Attenuator (VOA) (106), signals from all detectors are fed to a Signal Processing Unit (105) whose output controls the setting of all the VOAs and outputs from all VOAs being connected to a Multiplexer (107).

2. A system as claimed in claim 1, the non gain-flattened optical amplifier is an Erbium Doped Fiber Amplifier (EDFA).

3. A system as claimed in claim 1, the EDFA incorporates an amplified spontaneous emission (ASE) rejection filter.

4. A system as claimed in claim 1, the EDFA amplifies the incoming optical signal.

5. A system as claimed in claim 1, the gain of EDFA is set to overcome insertion losses due to the Demultiplexer, Coupling mechanism, Variable Optical Attenuators and Multiplexer and also to amplify the signal.

6. A system as claimed in claim 1, the EDFA is set for constant gain operation.

7. A system as claimed in claim 1, wherein the Coupling mechanism is a Tap Coupler.

8. A system as claimed in claim 1, where in the Tap Coupler has a rejection ratio of 99:1.

9. A system as claimed in claim 1, the tapped signals are detected using individual detectors.

10. A system as claimed in claim 1, the detected signals are fed to the Signal Processing Unit.

11. A system as claimed in claim 1, the Signal Processing Unit produces electric signals.

12. A system as claimed in claim 1, the electric signals controls the settings of corresponding Variable Optical Attenuators.

13. A system as claimed in claim 1, the VOA setting is controlled to obtain pre-emphasis in the channel.

14. A system as claimed in claim 1, the pre-emphasis of channels is achieved by setting the attenuation values of the channels that undergo lower gain to a relatively lower value than for the channels undergoing a relatively higher gain in the non gain-flattened amplifiers.

15. A system as claimed in claim 1, the pre-emphasis given to the channels is in accordance with the gain profile of the EDFA.

16. An optically amplified Dense Wavelength Division Multiplexed (DWDM) transmission system having improved channel OSNR, said transmission system comprising an Array of Transmitters (201) whose output is multiplexed using a Multiplexer (202), the multiplexed signal is amplified using a Booster Amplifier (203) and launched into a number of spans, one or more systems described in claim 1 to improve the OSNR (208) connected in between the spans, the signal from the last span is given to a Demultiplexer (209) and the demultiplexed signal is detected using an array of receivers (210).

17. A DWDM system as claimed in claim 16, wherein the transmitter array consists of 10Gbps externally modulated lasers (EML).

18. A DWDM system as claimed in claim 16, wherein the transmitter array includes 16 channels from ITU-T grid no. 22 to 37.

19. A DWDM system as claimed in claim 16, wherein the Booster Amplifier is a non gain-flattened EDFA, operating under constant power configuration.

20. A DWDM system as claimed in claim 16, wherein the transmission system comprises of twelve spans.

21. A DWDM system as claimed in claim 16, wherein each span consists of 80 Km of ITU-T G. 652 compliant Single Mode Fibers (SMF) (206), a Dispersion Compensation Fiber (DCF) (204) and two Inline Amplifiers ILA1 (207) and ILA2 (205).

22. A DWDM system as claimed in claim 16, wherein the Dispersion Compensation Fiber (DCF) compensates the accumulated dispersion of each span.

23. A DWDM system as claimed in claim 16, wherein the Inline Amplifier (ILA2) (205) makes up the nominal loss in the DCF.

24. A DWDM system as claimed in claim 16, wherein the Inline Amplifier (ILA1) (207) makes up for the nominal loss in the SMF.

25. A DWDM system as claimed in claim 16, wherein the Inline Amplifiers (ILA1 and ILA2) are non gain-flattened EDFAs.

26. A DWDM system as claimed in claim 16, wherein ILA1 and ILA2 are operated under constant gain conditions.

27. A DWDM system as claimed in claim 16, wherein the system to improve the OSNR (208) is implemented after the fourth span.
